(19) United States
(12) Patent Application Publication
(10) Pub. No.: US 2014/0255011 A1
(43) Pub. Date: Sep. 11, 2014

(54) MULTIMEDIA DEVICE AND PROMPT METHOD FOR SCHEDULED PROGRAMS

(71) Applicant: HON HAI PRECISION INDUSTRY CO., LTD., New Taipei (TW)

(72) Inventors: PEI-YING WANG, New Taipei (TW); JIAN-SHIHN TSANG, Tu-Cheng, New Taipei (TW)

(73) Assignee: HON HAI PRECISION INDUSTRY CO., LTD., New Taipei (TW)

(21) Appl. No.: 14/063,206

(22) Filed: Oct. 25, 2013

(30) Foreign Application Priority Data
Mar. 6, 2013 (TW) 102107775

(51) Int. Cl. H04N 21/458; H04N 21/4147

(52) U.S. Cl. CPC H04N 21/458; H04N 21/4147
USPC 386/296

(57) ABSTRACT

A multimedia device in communication with a communication device of a user is provided. The multimedia device sends a message to the communication device to remind the user that a selected scheduled program is about to start. The message includes at least a recording option and a watching option. The communication device transmits a recording instruction or a watching instruction to the multimedia device according to the user's choice, and the multimedia device records the scheduled program or tunes in to the scheduled program as chosen by the user. A prompt method for selected scheduled programs is also provided.

### BACKGROUND

1. Technical Field

The present disclosure relates to multimedia devices and prompt methods for scheduled television (TV) programs.

2. Description of Related Art

When a user wants to watch a specific TV program, the user needs to manually tune the TV to a desired channel when the TV program starts. However, the user needs to remember to tune into the TV program on a specific day, time, and channel number. Thus, the user may not remember which channel the television program is on and what time of day it is broadcasted, especially if the user wants to watch many different TV programs.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a multimedia device in accordance with an embodiment.

FIGS. 2 and 3 are flowcharts of a prompting method for scheduled programs in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

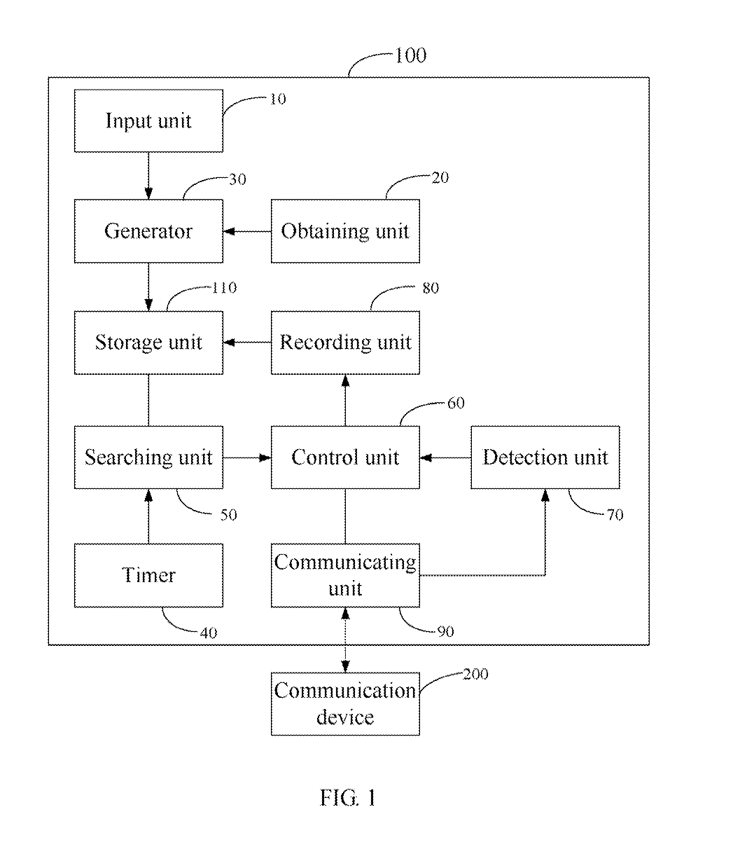

Referring to FIG. 1, a multimedia device 100 in communication with at least one communication device 200 is provided. The communication device 200 is operated by a user. The multimedia device 100 sends a message to the communication device 200 at a broadcasting time of a scheduled program to remind the user that the program is about to start broadcasting. The message includes at least a recording option and a watching option to allow the user to select via the communication device 200. The communication device 200 transmits a recording instruction or a watching instruction to the multimedia device 100 according to the user's selection. Thus, the multimedia device 100 records a scheduled program when the user is absent or watching another program, so that the user can watch the recorded program at a later time. The multimedia device 100 can be a television, a computer, or the like. In the embodiment, the multimedia device 100 is a television.

The multimedia device 100 includes an input unit 10, an obtaining unit 20, a generator 30, a timer 40 for keeping time, a searching unit 50, and a control unit 60. The multimedia device 100 further includes a storage unit 110, a detection unit 70, a recording unit 80, and a communicating unit 90. The communicating unit 90 communicates with the communication device 200 of the user and connects to the Internet by a wireless communication method. The communication device 200 can be a mobile phone of the user, for example.

The input unit 10 allows the user to search for a scheduled program and generates instructions for controlling the multimedia device 100. The input unit 10 can be buttons/keys or a touch panel of a housing of the multimedia device 100. The input unit 10 can also be a remote control of the multimedia device 100.

The obtaining unit 20 accesses program information. The program information includes at least a name, a start time, and an end time of each program. In the embodiment, the obtaining unit 20 assesses the program information from an electronic programming guide. The electronic programming guide can be stored in the storage unit 110 of the multimedia device 100 or can be downloaded from the Internet.

The generator 30 generates a schedule of the scheduled programs selected by the user. The schedule records at least the name, the start time, and the end time of each scheduled program. The schedule further records an identity (ID) of each program. The ID is composed of key words of the program to allow the user to search the scheduled program easily. The generator 30 further selects one or more programs as the desired scheduled program in response to manual operations of the user. As a result, users can select specific programs of interest. Furthermore, the generator 30 sets a prompt time and a prompt manner of the messaged sent to the communication device 200, thus, the prompt is sent at a prompt time according to a prompt manner as determined by the user. For example, the prompt time is 15 minutes before the start time of the scheduled program, and the prompt manner occurs at 1 minute intervals. The user can select which communication device 200 to receive the prompt.

The searching unit 50 determines whether or not a scheduled program selected by the user is about to start according to the timer 40. In the embodiment, when the time reaches the prompt time of one of the scheduled programs, it means that the scheduled program is about to start. For example, the start time of scheduled program A is 20:00, and the prompt time of the scheduled program A is 19:45, so the searching unit 50 determines that scheduled program A is about to start when the time reaches 19:45.

The control unit 60 generates a message to remind the user that a scheduled program is about to start and transmits the message to the communication device 200 via the communicating unit 90. The message includes at least the name and the start time of the scheduled program, a recording option, and a watching option. The communication device 200 returns a recording instruction to the multimedia device 100 when the recording option is selected, and returns a watching instruction to the multimedia device 100 when the watching option is selected.

When the time reaches the prompt time, the detection unit 70 detects whether or not the communicating unit 90 receives a recording instruction or a watching instruction from the communication device 200 within a predetermined time period. If the user wants to watch the scheduled program, the user sends a watching instruction to the communicating unit 90, and the control unit 60 tunes to the channel of the scheduled program. If the user wants to record the scheduled program, the user sends a recording instruction to the communicating unit 90, and the control unit 60 controls the recording unit 80 to record and store the scheduled program in the storage unit 110. In another embodiment, the scheduled program recorded by the recording unit 80 is stored in a remote storage device in communication with the multimedia device 100. As a result, the user can command the remote storage device to watch or download the recorded program. Furthermore, because of the large storage capacity of the remote storage unit, the storage unit 110 can store many downloaded programs.

The controlling unit 60 further determines whether or not the recording process of the scheduled program finishes. In the embodiment, when the time reaches the end time of the scheduled program, the control unit 60 controls the recording unit 80 to stop recording the program. Otherwise, the recording unit 80 continues to record the scheduled program.

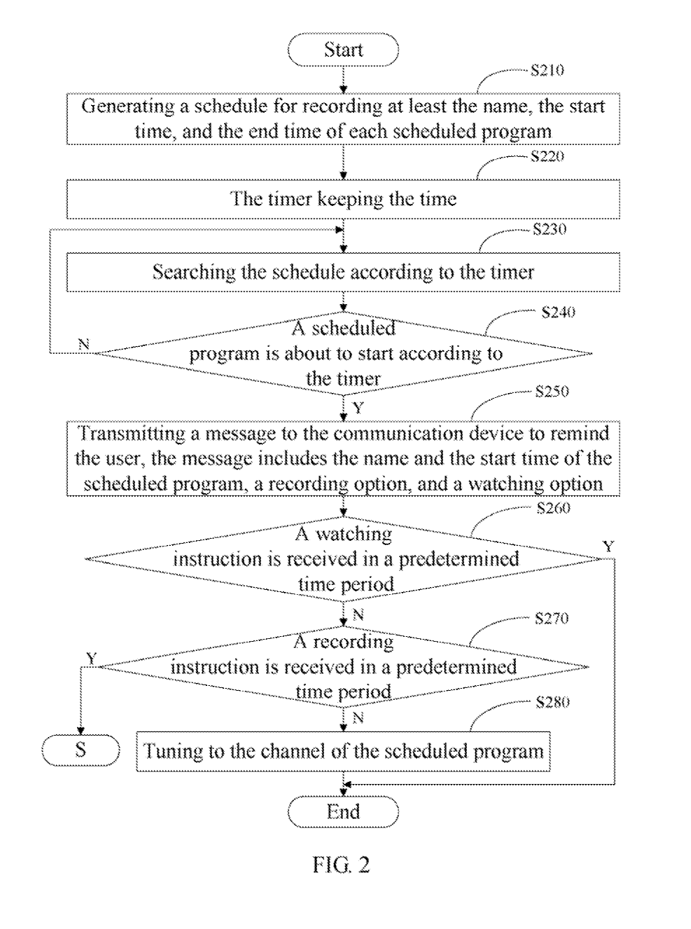

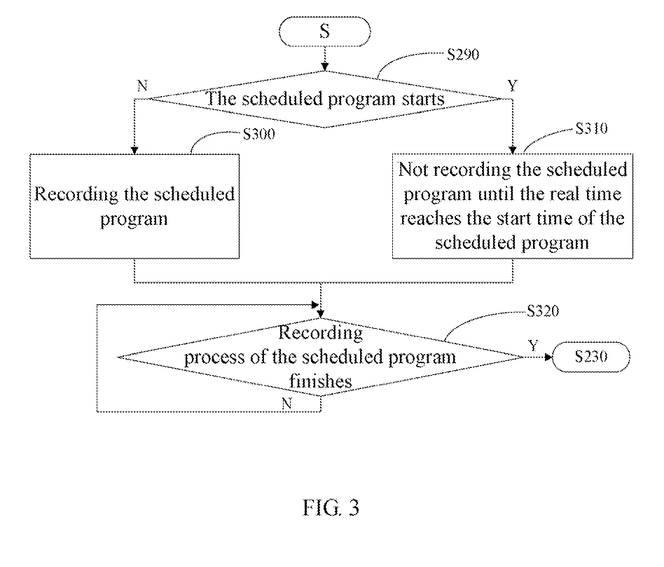

FIGS. 2 and 3 are flowcharts illustrating one embodiment of a prompt method for a scheduled program. The method includes the following steps:

In step S210, the generator 30 generates a schedule for recording at least the name, the start time, and the end time of each scheduled program selected by the user.

In step S220, the timer 40 keeps the time.

In step 5230, the searching unit 50 searches the schedule according to the timer 40.

In step S240, the searching unit 50 determines whether or not a scheduled program selected by the user is about to start according to the timer 40. When the time reaches a prompt time of a scheduled program, it is indicated that the scheduled time is about to start, and the procedure goes to step S250. Otherwise, when the time does not reach a prompt time of a scheduled program, the procedure returns to step S230.

In step S250, the control unit 60 generates a message to remind the user that the scheduled program is about to start and transmits the message to the communication device 200 of the user via the communicating unit 90. The message includes at least the name and the start time of the scheduled program, a recording option, and a watching option. The communication device 200 of the user transmits a recording instruction to the multimedia device 100 when the recording option is selected, and transmits a watching instruction to the multimedia device 100 when the watching option is selected.

In step S260, the detection unit 70 detects whether or not the communicating unit 90 receives a watching instruction from the communication device 200 within a predetermined time period. If the communicating unit 90 receives a watching instruction, the procedure goes to step S280. If the communicating unit 90 does not receive a watching instruction, the procedure goes to step S270.

In step S280, the control unit 60 tunes to the channel of the scheduled program.

In step S270, the detection unit 70 further detects whether or not the communicating unit 90 receives a recording instruction from the communication device 200 within the predetermined time period. If the communicating unit 90 receives a recording instruction, the procedure goes to step S290. If the communicating unit 90 does not receive a recording instruction, the procedure returns to step S230.

In step S290, the control unit 60 determines whether or not the scheduled program starts. If the scheduled program starts, the procedure goes to step S300. If the scheduled program does not start, the procedure goes to step S310.

In step S300, the recording unit 80 records the scheduled program, and the procedure further goes to step S320.

In step S310, the recording unit 80 does not start recording the scheduled program until the time reaches the start time of the scheduled program, and the procedure goes to step S320.

In step S320, the control unit 60 determines whether or not the time reaches the end time of the scheduled program. In the embodiment, when the time reaches the end time of the scheduled program, the control unit 60 controls the recording unit 80 to stop recording the scheduled program. When the recording process of the scheduled program finishes, the procedure returns to step S230. When the time does not reach the end time of the scheduled program, the recording unit 80 continues to record the scheduled program.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A multimedia device communicating with at least one communication device, comprising;
a timer;
a generator generating a schedule for recording at least the name, and the start time of each scheduled program selected by the user;
a recording unit recording the scheduled program;
a searching unit determining whether a scheduled program is about to start according to the timer;
a control unit transmitting a message to the communication device to remind the user when a scheduled program is about to start according to the timer; wherein the message comprises at least the name and the start time of the scheduled program, and a recording option, the communication device transmits a recording instruction to multimedia device when the recording option is selected; and
a detection unit detecting whether the multimedia device receives a recording instruction in a predetermined time period when the scheduled program is about to start;
wherein the control unit controls the recording unit to record the scheduled program when the multimedia device receives a recording instruction in the predetermined time period.

2. The multimedia device of claim 1, wherein the control unit further determines whether the scheduled program starts, and controls the recording unit to record the scheduled program directly when the scheduled program starts.

3. The multimedia device of claim 2, wherein the recording unit does not record the scheduled program until the scheduled program starts.

4. The multimedia device of claim 3, wherein the scheduled program is determined to start when the time reaches the start time of the scheduled program.

5. The multimedia device of claim 1, wherein the message further comprises a watching option, the communication device transmits a watching instruction to the multimedia device when the watching option is selected.

6. The multimedia device of claim 5, wherein the detection unit detects whether the multimedia device receives a watching instruction, the control unit tunes to the channel of the scheduled program when the multimedia device receives the watching instruction.

7. The multimedia device of claim 1, further comprising an obtaining unit accessing program information, wherein the generator generates a schedule of the scheduled programs selected from the accessed program information by the user.

8. The multimedia device of claim 1, wherein the schedule further records a prompt time and a prompt manner corresponding to each scheduled program, the prompt time is before the start time of the scheduled program.

9. The multimedia device of claim 8, wherein the searching unit determines that the scheduled program is about to start when the time reaches the prompt time.

10. A prompt method for a scheduled program, the method being implemented by a multimedia device comprising a timer for keeping time, and a recording unit for recording the scheduled program, the method comprising:
generating a schedule for recording at least the name, and the start time of each scheduled program selected by the user;
determining whether the scheduled program is about to start according to the timer;
transmitting a message to a communication device communicating with the multimedia device to remind the user when the scheduled program is about to start;
wherein the message comprises at least the name and the start time of the scheduled program, and a recording option; the communication device transmits a recording instruction to multimedia when the recording option is selected;
detecting whether the multimedia device receives a recording instruction in a predetermined time period when the scheduled program is about to start; and
controlling the recording unit to record the scheduled program when the multimedia device receives a recording instruction in the predetermined time period.

11. The prompt method according to claim 10, further comprising:
determining whether the scheduled program starts;
recording the scheduled program when the scheduled program starts; and
not recording the scheduled program until the scheduled program starts.

12. The prompt method according to claim 11, wherein the scheduled program is determined to start when the time reaches the start time of the scheduled program.

13. The prompt method according to claim 10, wherein the message further comprises a watching option, the communication device transmits a watching instruction to the multimedia device when the watching option is selected.

14. The prompt method of claim 13, further comprising:
detecting whether the multimedia device receives a watching instruction; and
tuning to the channel of the scheduled program when the multimedia device receives the watching instruction.

15. The prompt method of claim 10, wherein the schedule further records a prompt time and a prompt manner corresponding to each scheduled program, the prompt time is before the start time of the scheduled program.

16. The prompt method of claim 15, further comprising:
detecting whether the time reaches the prompt time; and
determining that the scheduled program is about to start when the time reaches the prompt time.
